(19) United States
(12) Patent Application Publication
(10) Pub. No.: US 2023/0153799 A1
(43) Pub. Date: May 18, 2023

(54) COMPUTERIZED TRADING SYSTEM FOR ASSET-BASED, SMART-CONTRACT TOKENS INCLUDING AUTOMATED DECENTRALIZED AUTONOMOUS ORGANIZATION TOKEN AND ASSET TRANSFER

(71) Applicant: MR Innovations LLC, Chicago, IL (US)

(72) Inventors: Donald R. Wilson, JR., Chicago, IL (US); Christopher Robert Zuehlke, Chicago, IL (US); Samuel F. Courtney, Chicago, IL (US)

(21) Appl. No.: 17/990,270

(22) Filed: Nov. 18, 2022

Related U.S. Application Data
(60) Provisional application No. 63/281,072, filed on Nov. 18, 2021.

(51) Int. Cl. G06Q 20/38; G06Q 20/36

(52) U.S. Cl. CPC G06Q 20/381; G06Q 20/389; G06Q 20/3678; G06Q 2220/00

(57) ABSTRACT

An automated computerized trading system is provided wherein a decentralized autonomous organization (DAO) includes a wallet having blockchain-based, smart-contract controlled cryptoassets associated with a commodity. The DAO receives data infeed from Application Programming Interfaces (APIs) from the blockchain to obtain cryptoasset price data and from an exchange to obtain commodity price data. The DAO stores commodity price and cryptoasset price spread targets and automatically initiates trading activity based on the price spread targets. A governance smart contract automatically distributes governance cryptoassets to public wallets that have contributed the crytpoassets to the DAO wallet.

### CROSS-REFERENCE TO RELATED APPLICATIONS

The present application claims the benefit of U.S. Provisional Application No. 63/281,072, filed Nov. 18, 2021, entitled “Computerized Trading System For Asset-Based, Smart-Contract Tokens Including Automated Decentralized Autonomous Organization Token And Asset Transfer”, which is hereby incorporated by reference in its entirety.

### BACKGROUND OF THE INVENTION

The present invention generally relates to an automated trading system. More particularly, the present invention relates to an automated trading system controlled by a decentralized autonomous organization (DAO).

There can be costs associated with the carry of or the holding of real-world assets. For example, holders of precious metal bullion must generally pay an annual vaulting cost to store the bullion. The tokenization of any of these real-world assets via smart-contracts must account in one way or another for the expense of holding the real-world assets underlying their respective tokens. Existing solutions both in the blockchain space and in the physically-backed exchange traded fund (ETF) space distribute these costs to asset holders via a limited set of methods.

An example of one such method that has been tried with respect to tokenizing gold bullion is as follows: a smart contract-based system enables the creation of tokens that are each backed by one fine troy ounce (the term fine troy ounce is hereafter referred to interchangeably with the term troy ounce) of a 400 oz London Good Delivery gold bar held in a London Bullion Market Association (LBMA) accredited vault in London. New tokens are minted via the deposit of one fine troy ounce of London Good Delivery bullion into a specified LBMA accredited London vault, while existing tokens can be correspondingly burned for removal of one fine troy ounce of London Good Delivery bullion in the same specified LBMA accredited vault. The ratio of gold tokens to underlying London Good Delivery bullion remains at one fine troy ounce to one token over time.

Such a system, with tokens representing a claim on the underlying physical asset of LBMA good delivery gold bullion bars, can generate fees via two methods:

1. Mint and burn fees: A one-time fee in basis point (bps) terms can be applied to the notional value of the underlying London Good Delivery bullion with respect to which tokens are being minted or burned.

Example: London Good Delivery bullion is priced at $2,000/fine troy ounce. The creation fee is 10 bps. A customer desiring to mint a gold token would deliver one fine troy ounce of LBMA Good Delivery bullion and receive 0.999 gold tokens (equal to 1 fine troy oz—( 10/10,000)). The 0.001 difference from LBMA Good Delivery bullion and gold tokens received would be collected as a fee by the token protocol operator in the form of gold tokens, thus keeping the ratio of gold bullion to gold tokens 1:1.

2. Token transfer fees: A fee can be charged each time a token representing London Good Delivery bullion is transferred from one blockchain address to another. The fee would be applied in-kind with respect to the number of tokens being transferred, with the recipient of the transfer receiving fewer tokens than the amount sent by the transferrer.

Example: A gold token holder (transferrer) sends one gold token to a second party (recipient) via the applicable blockchain. The transfer fee is 2 bps. The transferrer incurs a cost of 0.0002 gold tokens (equal to 1 token×( 2/10,000)) and the recipient receives 0.9998 gold tokens (equal to 1 token−0.0002 token fee). The transfer fee is received by the token protocol operator, thus keeping the ratio of gold bullion to gold tokens 1:1.

The physically-backed gold ETF industry fee structure differs from the fee structure implemented in existing smart contract-based systems for tokenizing physical gold in that it uses annual fees (applied daily), which reduce the quantity of the underlying physical-world assets that exist per share of the ETF. In this way, the ratio of underlying gold bullion to the outstanding ETF shares is not kept constant, but rather decays at a rate equivalent to the annual management fee.

Example: London Good Delivery bullion is priced at $2,000/fine troy ounce. The annual ETF management fee is 40 bps, applied to the underlying LBMA Good Delivery bullion. The amount of underlying LBMA Good Delivery bullion is 1,000 fine troy ounces on day T=0, with 1,000 ETF shares. The number of fine troy ounces underlying each share on day T=0 is 1:1. In the case of no further share creations or redemptions, the application of the management fee on day T+1 would reduce the amount of underlying gold LBMA Good Delivery bullion per share by 0.000011 troy ounces (−0.40% annualized fee/365 days)×1 day. Therefore, the number of fine troy ounces underlying each share after one year would be 1:0.996.

### BRIEF SUMMARY OF THE INVENTION

One or more embodiments of the invention provide a smart contract-based system for tokenizing real-world assets such as commodities that have storage costs or other costs-of-carry such that such tokenized assets do not require deflationary unit fees paid in the underlying token. The absence of fees deflationary to the underlying token holdings make such tokens suitable to be locked as collateral in smart contracts such as those used in decentralized finance (DeFi) protocols.

In one embodiment, a decentralized autonomous organization (DAO) implements an automated computerized trading system. The DAO includes a wallet receiving blockchain-based, smart contract controlled cryptoassets that are associated with a commodity. Cryptoasset price data is provided to the DAO from the blockchain through a first Application Programming Interface (API) and commodity price data is provided to the DAO from one or more exchanges through a second API. The DAO includes a database storing commodity price and cryptoasset price spread targets and automatically initiates trading activity based on the price spread targets. A governance smart contract automatically distributes governance cryptoassets to public wallets that have contributed the crytpoassets to the DAO wallet.

### BRIEF DESCRIPTION OF THE DRAWINGS

FIG. 1 illustrates a flowchart of the system for pledging TXAU tokens to the DAO wallet, according to a preferred embodiment.

FIG. 2 illustrates a flowchart of the system for withdrawing TXAU tokens that are pledged to the DAO wallet, according to a preferred embodiment.

FIG. 3 illustrates a flowchart of a GXAU automated token allocation system implemented as a smart contract according to an embodiment of the present invention.

FIG. 4 illustrates a flowchart of the system for withdrawing GXAU tokens that are pledged to the DAO wallet, according to a preferred embodiment.

FIG. 5 illustrates a flowchart of the DAO automated computerized trading system, according to an embodiment of the present invention.

FIG. 6 illustrates a flowchart of the allocation of TXAU and/or stable coin produced by automated market operations, according to an embodiment of the invention.

FIG. 7 illustrates a flowchart of the DAO automated computerized trading system wherein TXAU is automatically converted to stable coins which are then used to automatically purchase XAU, according to an embodiment of the present invention.

### DETAILED DESCRIPTION OF THE INVENTION

### Problem with Legacy Tokenization Approach

There are deficiencies in the existing solutions for the application of cost-of-carry fees in both the tokenized physical gold space and in the precious metals ETF space. In respect of the former, tokens representing real-world assets that have carrying costs cannot readily be pledged as collateral within many DeFi protocols due to the transfer fees built into the tokens, because such fees steadily erode the collateral value of the tokens. Such tokens also suffer from adverse selection by not charging annual maintenance fees; persons wanting long-term exposure to gold are incentivized to hold existing gold tokens rather than gold bullion in order to avoid paying storage fees. In respect of the latter, the efficiency of using ETF shares for collateral posting purposes is weakened by the dynamic whereby the value of pledged asset decays through the daily application of management fees. The denomination of gold tokens in smaller increments than London Good Delivery bullion and ETF shares enables the trading of value in round lots, even though the underlying assets may change by small amounts.

The challenges facing gold tokens and gold ETFs are not unique to the precious metals market and instead apply to the tokenization or securitization of any real-world asset with an associated cost of carry. Other instruments such as central bank digital currencies would also face this problem in an environment of negative interest rates. Negative carry is currently only applied to token or physically-backed ETF holders via the three methods outlined above, with no means of transforming negative carry into a positive receipt via token mechanisms.

### Token Solution

One way to tokenize real-world assets that have storage costs or other costs-of-carry such that the tokenized assets are suitable for use as collateral in DeFi protocols without introducing avenues to avoid such costs involves a two-part solution that includes 1) the use of a smart-contract governed, collateralized token, divisible to (six decimal points), that at time=0 will represent a given quantity of the underlying asset, and 2) in the first embodiment of the invention, a corresponding governing protocol in the form of a DAO responsible for maintaining the token peg to the real-world asset via automated trading mechanics.

An example of a smart-contract governed, London Good Delivery gold bullion collateralized token is hereafter referred to as TXAU. TXAU tokens each have a proportional claim on the total physical gold bullion backing the tokens. For example, if the total physical holdings backing the tokens was 1,201 fine troy ounces and there were 1,200 tokens, each token would be backed by 1.000833 fine troy ounces (rounded to 1.000 per LBMA rounding procedures) of London Good Delivery gold bullion. (In the event of physical creation/redemption, the weight of physical fine gold is rounded to three decimal points in accordance with the LBMA's rounding procedures.) The amount of physical gold bullion backing each TXAU token would fluctuate based on the activities of the governing protocol. TXAU tokens would not incur transfer fees if the tokens were to move across cryptoasset wallet addresses.

One embodiment of implementing a smart contract would be to implement the token on the Ethereum blockchain as an ERC20 token. For example, TXAU token transfers would occur on the Ethereum blockchain and would follow the standard steps of token transfers on the Ethereum blockchain.

TXAU tokens may be minted or burned with the DAO as outlined in the SYSTEM of GOVERNANCE and TOKEN CREATION AND REDEMPTION sections below. The minting or burning of TXAU tokens would incur an in-kind fee as outlined in the BACKGROUND section above—a one-time fee in basis point (bps) terms that can be applied to the notional value of the underlying London Good Delivery bullion with respect to which tokens are being minted or burned. The minting and burning of TXAU would follow the standard steps of minting and burning tokens on the Ethereum blockchain.

In the first embodiment of the invention, an example of a smart-contract governed, DAO governance token is hereafter referred to as GXAU. In a first embodiment, GXAU tokens would each have a proportional claim on the TXAU assets of the DAO as well as pro rata governance voting rights. However, in a second embodiment, GXAU holders would not have a proportional claim on the TXAU assets of the DAO and would only have governance voting rights. The amount of DAO treasury assets backing each GXAU token would fluctuate based on the trading activities of the DAO as further described below. The release schedule of GXAU to holders of TXAU would follow the schedule described below. GXAU token transfers would occur on the Ethereum blockchain and would follow the standard steps of token transfers on the Ethereum blockchain.

In a first embodiment, GXAU may be pre-mined up to a predetermined limit such at 1 million total GXAU. Additionally, on a block-by-block basis additional GXAU may be given to TXAU stakeholders based on their pro-rata pledged or staked TXAU. In one embodiment, 10 GXAU tokens may be allocated with each Ethereum block on a pro-rata basis to public wallet addresses that have pledged TXAU as of that Ethereum block. Once a GXAU token has been allocated to a public wallet address, that public wallet address may initiate a withdrawal of the GXAU token by transferring the GXAU token from the DAO's wallet to the public wallet address as described below.

In a second embodiment, instead of the GXAU being pre-minted, the GXAU may be mined at each Ethereum block and then allocated to the to the public wallet addresses associated with pledged TXAU as of that block on a pro-rata basis of the amount of TXAU pledged by each private wallet address.

### System of Governance—First Embodiment of the Invention

In the first embodiment of the invention, holders of TXAU tokens would have the option to lock (which may also be known as pledging) TXAU tokens in the DAO by sending their TXAU tokens to a DAO controlled multi-signature wallet using standard blockchain transfer, thereby restricting access to the TXAU tokens because only the DAO would have access to the private keys of the multi-signature wallet private key holders would be limited to the DAO. While the multi-signature wallet would have multiple private keys, the DAO would control all of them. Thus, the DAO would have the ability to move any TXAU locked in the DAO wallet through the use of the wallet private keys.

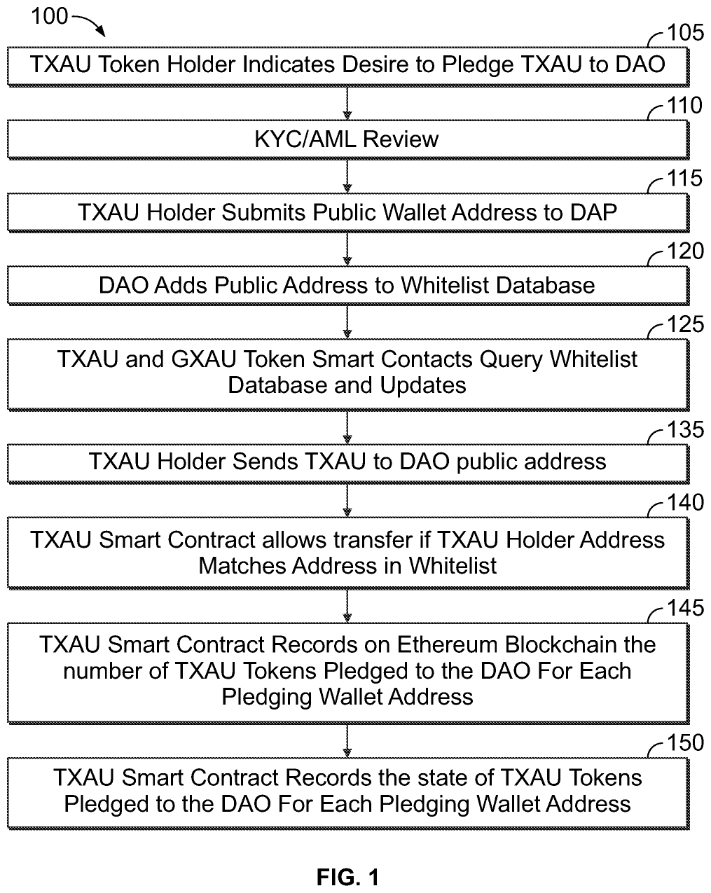

FIG. 1 illustrates a flowchart 100 of the system for pledging TXAU tokens to the DAO wallet, according to a preferred embodiment. First, at step 105 the TXAU token holder indicates a desired to pledge TXAU to the DAO, for example by requesting access using an application. At step 110, any TXAU token holder seeking to pledge TXAU tokens to the DAO would undergo a Know-Your-Customer/Anti-Money Laundering (KYC/AML) review process administered by the DAO. Such a process would typically take the form of an internet application that would be operating on a computerized system controlled by the DAO. The application would allow the DAO to receive and store the electronic information received. The electronic information received would be reviewable through the application using a compliance process performed at the DAO. Unless approved through the compliance process, no further steps would take place and access to the DAO wallet would not be allowed.

Next, at step 115, following successful completion of a KYC/AML review process, the TXAU token holder would submit their Ethereum wallet public address to the DAO via electronic message to be whitelisted by the DAO. TXAU token holders that successfully completed a KYC/AML review will hereafter be referred to as approved pledgers.

At step 120, the DAO electronically stores a whitelist representing an electronic database of public wallet addresses that could contribute TXAU tokens to the DAO wallet because they have passed the compliance process. In addition, the DAO electronically stores a predetermined total maximum amount of TXAU tokens eligible to be pledged to the DAO wallet. During or following the completion of the compliance process, once a public wallet address is received via electronic message from an approved pledger, the DAO would enter the public wallet address into the whitelist on the electronic database accessible only by the DAO.

At step 125, the TXAU and GXAU token smart contracts automatically query the electronic whitelist database maintained by the DAO and update the data section of the TXAU and GXAU smart-contracts with each new Ethereum block to match the whitelisted addresses from the electronic database maintained by the DAO. In an alternative embodiment, the TXAU smart contract would also automatically query the total maximum amount of TXAU tokens eligible to be pledged to the DAO wallet stored on the electronic database accessible only by the DAO and update the data section of the TXAU smart-contract with each new Ethereum block to match the electronic database.

At step 135, transfers of TXAU tokens to the DAO treasury would be under conditional permission such that the sender's wallet address must be included on the data section of the TXAU smart-contract representing the copy of the whitelist that had been stored in the smart-contract. If a TXAU token holder attempted to send the TXAU to the public Blockchain address associated with DAO treasury wallet using standard blockchain techniques, the TXAU smart contract would reference the wallet address of the sender and compare the wallet address to the whitelisted wallet addresses stored in the data section of the TXAU smart-contract. If the sender's wallet address were not included on the data section of the TXAU smart-contract, the TXAU smart contract would automatically reject the transfer.

At step 140, if the sender's wallet address were included in the data section of the TXAU smart-contract, the smart-contract would allow the transaction to proceed and would transfer the TXAU to the Blockchain address associated with the DAO treasury wallet.

At step 145, the TXAU smart contract records with each Ethereum block the pledged status of each TXAU token held in the DAO wallet per wallet address that sent the TXAU to the DAO wallet. Thus, for each wallet address that has transferred TXAU to the DAO's private wallet address, a data structure records the number of TXAU tokens that been pledged from that wallet address.

At step 150, the TXAU smart contract records the state of the TXAU tokens that have been pledged from each wallet address. In a first example, all TXAU received at the DAO wallet is automatically pledged when received. However, the status of the token at a later point may include any of three states: 1) pledged (available for use in trading by the DAO), 2) pending unpledged (unavailable for use in trading by the DAO and undergoing a “cool down” period as described below), and 3) unpledged and eligible for withdrawal. The three states would be stored at the level of the smart-contract and would be accessible during the withdrawal process described below. The withdrawal functionality would be directly coded into the smart-contract and any whitelisted cryptoasset wallet address associated with the deposit of TXAU into the DAO wallet would have the ability to withdraw TXAU as described below. The TXAU smart-contract would automatically implement a timing restriction so that any TXAU tokens held in the DAO wallet would require a T+2 business day (as defined by the LBMA) “cool off” period before the TXAU token was unpledged and could be withdrawn to approved pledgers. The T+2 business day period as defined by the LBMA would be automatically converted to a number of Ethereum blocks through a calculation by the smart-contract. The smart-contract generates the number of Ethereum blocks representing the T+2 business days by referencing 1) an electronic database maintained by the DAO that included LBMA business dates and times, 2) the current date and time, and 3) an oracle that converted future dates and times into a number of expected Ethereum blocks based on historical Ethereum Blockchain activity.

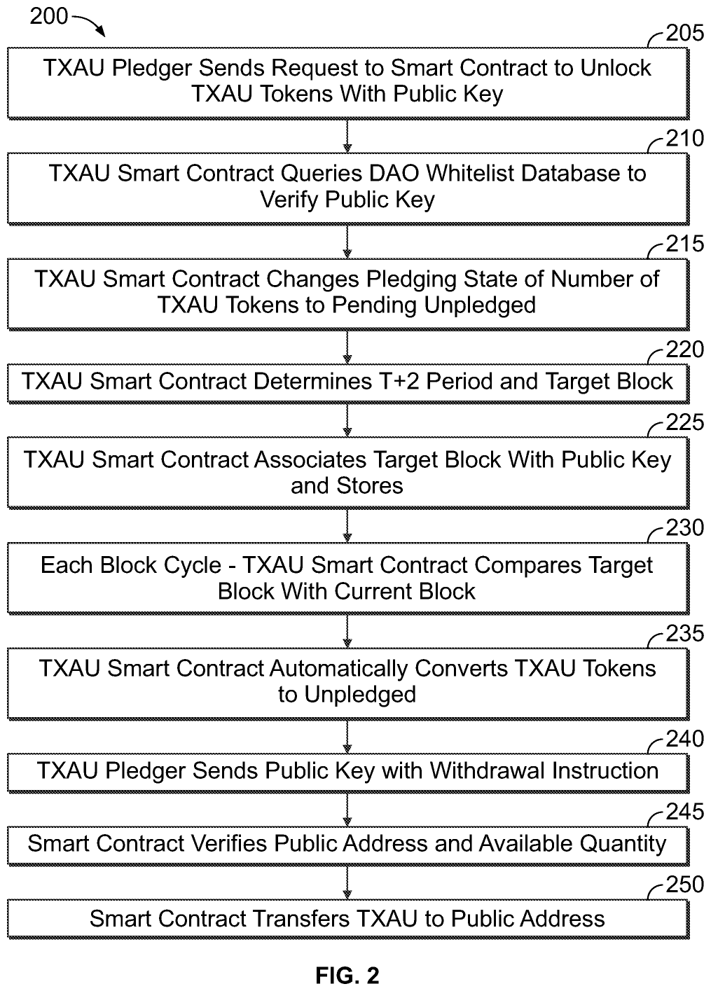

FIG. 2 illustrates a flowchart 200 of the system for withdrawing TXAU tokens that are pledged to the DAO wallet, according to a preferred embodiment. First, at step 205, previously approved pledgers that had sent TXAU to the TXAU DAO wallet request to unlock a specified number of their pledged TXAU tokens by sending a message with their public key via a security controlled application to the TXAU smart contract with instructions to change the pledging state of a specified number of TXAU. At step 210, the TXAU smart contract then automatically queries the electronic database maintained by the DAO to verify the message was sent by a whitelisted address. At step 215, when the message was sent by a whitelisted address, the smart contract automatically changes the pledging state of the specified number of TXAU tokens on the TXAU smart contract. If the message sent by the whitelisted address requesting to change the pledging state of tokens included a quantity of tokens that exceeded the number of tokens recorded on the smart contract as being allocated to the approved pledger, the message would be automatically rejected.

In another embodiment, the request to unlock a specified number of tokens may be sent to the DAO using the secure application described above to perform the compliance process. Once received by the DAO, the DAO would change the state of the specified number of tokens. For example, the DAO may receive a public key and a number of tokens to unlock from an approved TXAU pledger. The DAO may verify that at least that number of tokens is associated with that approved TXAU ledger and then adjust the smart-contract entry associated with the public key to shift the number of tokens in the status of pledged to the status of pending unpledged.

Next, at step 220, upon conversion from pledged to pending unpledged, the smart-contract automatically calculates the number of block cycles representing the T+2 period as described above, and generates a target block where the pending unpledged status would convert to an unpledged status. At step 225, the target block is stored in the smart-contract associated with the public key. Then, at step 230, at each block cycle the smart-contract queries each wallet holding with a pending unpledged status and compares the current block cycle with the target block automatically generated by the smart-contract. At step 235, when the target block is reached, the smart-contract automatically converts the status of the TXAU associated with the public address from pending unpledged to unpledged.

At step 240, after the pledged status of a TXAU token changed to “unpledged and eligible for withdrawal” on the Ethereum blockchain, approved pledgers request to withdraw a specified number of their TXAU tokens by sending a message with their public key via a security controlled application to the TXAU smart contract with instructions to withdraw a specified number of TXAU. At step 245, the TXAU smart contract then automatically queries the electronic database maintained by the DAO to verify the message was sent by a whitelisted address. Next, at step 250, when the message was 1) sent by a whitelisted address, and 2) the status of the TXAU token was “unpledged and eligible for withdrawal”, then the smart contract withdraws the specified number of TXAU tokens from the TXAU wallet and deposit the TXAU tokens into the whitelisted wallet of the approved pledger. The withdrawal and deposit are accomplished by the smart contract initiating a transfer of TXAU from the DAO wallet to the wallet indicated by the public address requesting withdrawal. The message is rejected if both of the above criteria were not met.

In another embodiment, the request to withdraw a specified number of tokens may be sent to the DAO using the secure application described above to perform the compliance process. Once received by the DAO, the DAO would verify that at least that number of tokens is associated with that approved TXAU public address requesting withdrawal in the status of pending unpledged, and then send the requested TXAU tokens the to the public wallet address of the approved pledger.

The same process of unpledging and withdrawing TXAU from the wallet controlled DAO would be applied to unpledging and withdrawing U.S. dollar stablecoins such as USDC from the separate wallet controlled by the DAO.

In order to determine the amount of TXAU tokens sent by each wallet address to the DAO wallet address and in a pledged state, along with the aggregate amount of TXAU tokens held in the DAO wallet address and in a pledged state, the automated token allocation system directly coded into the TXAU smart contract would automatically query on a block by block basis the TXAU blockchain data. Then, the amount of TXAU tokens sent by each wallet address to the DAO wallet address and in a pledged state, and the aggregate amount of TXAU tokens held in the DAO wallet address and in a pledged state would be stored in the smart contract. Any TXAU tokens sent by a wallet address to the DAO TXAU wallet and in a pledged state would be eligible (because they are in a pledged state) for GXAU and TXAU rewards automatically calculated on a pro rata by public address. This calculation will be redone every block according to the number of TXAU tokens in a pledged state. The TXAU smart contract would automatically calculate and store on a block-by-block basis, the pro rata basis calculated using TXAU is also used to calculate GXAU rewards automatically and allocate them to the indicated public address.

A DAO controlled multi-signature GXAU reward wallet would hold GXAU used to reward approved pledgers. While the multi-signature wallet would have multiple private keys, the DAO would control all of them. Thus, the DAO would have the ability to move any GXAU locked in the DAO wallet through the use of the wallet private keys.

The GXAU reward emission schedule, represented by the number of total GXAU rewards to be released each block across all eligible wallet addresses, is input to and stored in an electronic database maintained by the DAO. In a first embodiment, the emission/release/unlocking schedule may be static, such as a predetermined number of GXAU tokens per block. In a second embodiment, holders of the GXAU token may vote on the associated emission schedule, with votes allocated pro rata based on GXAU token holdings.

The GXAU automated token allocation system may be directly coded into the GXAU smart contract. The status of a GXAU token may include one of two states: 1) locked, and 2) unlocked. For example, in a first embodiment of the GXAU allocation system, the total amount of GXAU is pre-mined. The pre-mined GXAU may then be stored in the wallet of the DAO and may have a status of “locked”. In one example, when the GXAU has been allocated to a public wallet address based on that public wallet address's pro-rata ownership of TXAU at a certain Ethereum block, the specified amount of GXAU is then associated in a database at the DAO with the specific public wallet address and the status of the GXAU is changed to “unlocked”. Subsequently, the designated public wallet address may initiate a transfer/withdrawal of the GXAU from the wallet of the GXAU to the wallet specified by the designated public address, as further described herein.

In a second embodiment, wherein the GXAU is not pre-minted, but instead mined at an Ethereum block, the GXAU may omit the “locked” state and may instead immediately be associated in the DAO with the specific public address with a status of “unlocked”.

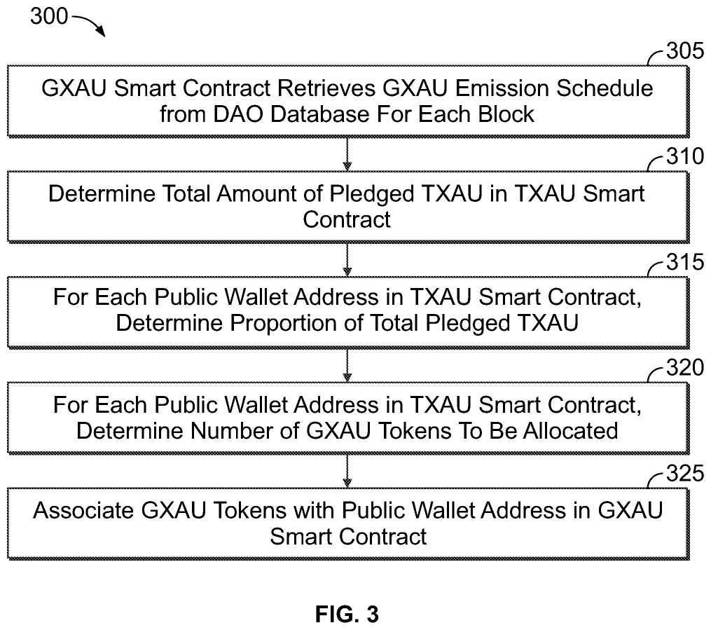

FIG. 3 illustrates a flowchart 300 of a GXAU automated token allocation system implemented as a smart contract according to an embodiment of the present invention. First, at step 305, the GXAU automated token allocation system automatically queries and stores on a block by block basis the GXAU reward emission schedule on the electronic database maintained by the DAO to automatically calculate the gross number of GXAU reward tokens from the DAO controlled GXAU reward wallet to distribute per block. At step 310, the GXAU smart contract determined the total amount of pledged TXAU in the TXAU Smart Contract. Then, at step 315, the GXAU smart contract also queries and stores on a block-by-block basis the GXAU reward proportion metric per wallet address stored on the TXAU smart contract. In one embodiment, the reward emission schedule is 10 tokens per block moved from a locked status to an unlocked status by the smart contract. At step 320, the GXAU smart contract then automatically calculates and stores on a block-by-block basis, the number of GXAU reward tokens to be automatically allocated to each approved pledger wallet address according to the product of the GXAU reward proportion per wallet and the GXAU reward emission per block. Finally, at step 325, for each public address that is determined to receive GXAU tokens, the GXAU smart contracts associates the calculated GXAU tokens with the public address.

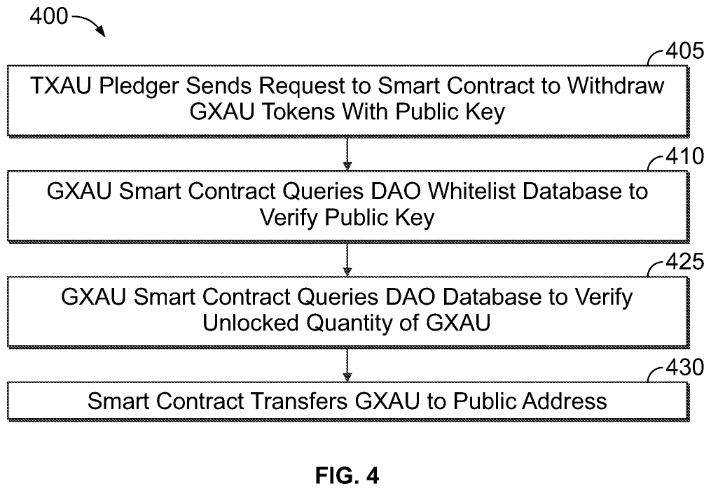

FIG. 4 illustrates a flowchart 400 of the system for withdrawing GXAU tokens that are pledged to the DAO wallet, according to a preferred embodiment. Similar to the process described above with regard to the withdrawal of TXAU tokens, at step 405 approved pledgers may request to withdraw a specified number of their unlocked GXAU tokens from the DAO GXAU treasury wallet by sending a message with their public key (or public wallet address) via a security controlled application to the GXAU smart contract with instructions to withdraw a specified number of GXAU. At step 410, the GXAU smart contract then automatically queries the electronic database maintained by the DAO to verify the message was sent by a whitelisted address. Next, at step 425, the DAO smart contract then automatically queries the electronic database maintained by the DAO to verify the quantity of unlocked GXAU that is associated with the public key. Then, at step 430, when the message was sent by a whitelisted address and the status of the GXAU token was unlocked, the smart contract may withdraw the specified number of GXAU tokens from the DAO controlled GXAU wallet and deposit the GXAU tokens into the whitelisted wallet of the approved pledger's public key.

In another embodiment, the request to withdraw a specified number of tokens may be sent to the DAO using the secure application described above to perform the compliance process. Once received by the DAO, the DAO would verify that at least that number of tokens is associated with that approved GXAU public address in the status of unlocked, and then send the requested GXAU tokens the to the public wallet address of the approved pledger. If the public address is not included in the whitelist or the number of GXAU tokens requested exceeds the number of unlocked tokens associated with that public address, then no transfer takes place.

In another embodiment, as described below, an automatically determined proportion of the TXAU generated on a daily basis via automated pair spread arbitrage trading activity would be transferred into the DAO TXAU wallet by the DAO. The TXAU smart-contract data structure recording the number of TXAU tokens that had been pledged from each wallet address would be automatically increased on a pro-rata basis computed by the amount of TXAU tokens sent by each wallet address to the DAO wallet address and in a pledged state divided by the aggregate amount of TXAU tokens held in the DAO wallet address and in a pledged state. The newly deposited TXAU tokens would be automatically pledged when received in the DAO wallet.

In a second embodiment of the invention, holders of TXAU tokens seeking to lock TXAU tokens in the DAO by sending their TXAU tokens to a cryptoasset wallet with private keys controlled by the DAO would also be required to lock a predetermined ratio of U.S. dollar stablecoins (e.g. USDC) in the DAO by sending the stablecoins to a separate cryptoasset wallet with private keys controlled by the DAO. The DAO would maintain an oracle with respect to the ratio of stablecoins required to be sent with the TXAU to DAO controlled cryptoasset wallets. In one embodiment, the oracle would transmit a required ratio of the notional value of TXAU tokens to U.S. dollar stablecoins of 70:30. In one embodiment, a tolerance level of 5% is imposed by the smart-contract. In one embodiment, the notional value of a TXAU token as calculated by an oracle would be the mid-point price of the DAO TXAU bid/ask price as published by another TXAU DAO oracle. The DAO would also maintain a web portal that supported multi send by smart contract to enable two tokens (TXAU and a stablecoin) to be sent to the DAO TXAU and stablecoin wallets in the same transaction. If the sender did not include the TXAU and the required ratio of stablecoins in the same transaction, the TXAU smart contract would reject the TXAU transfer.

The DAO would maintain a price oracle with respect to the bid and ask price of the TXAU token. The price oracle would be required to constantly broadcast prices during LBMA market hours via a standardized message format over API representing the outputs of its calculations of the theoretical bid and ask price of TXAU. In one embodiment, the theoretical bid and ask price are calculated by receiving the top of book bid and ask price from five computerized liquidity venues (such as cryptoasset central limit order books or decentralized finance exchanges) and applying an equal weight to each bid and ask price to generate composite bid and ask prices.

The DAO would be required to be capable of supporting the minting or burning of TXAU tokens. Such creation or redemption activities must be executed within a predetermined spread range to the TXAU bid/ask prices broadcast by the price oracle. For example, mint or burn activities within a quantity of 10 TXAU tokens must be executed within a spread range of 5 basis points from the bid/ask prices.

The DAO would be required to support the management of vaulting operations in segregated accounts at LBMA approved vaults in London to facilitate the creation and redemption of TXAU tokens. The DAO would be required to publish daily Good Delivery bar bullion vault holdings via an oracle specifying the number of fine troy ounces of gold associated with TXAU under their operational control. The total vault holdings published by the DAO oracle would equal the total physical gold bullion backing the TXAU tokens.

Holders of TXAU tokens that pledged TXAU tokens to the DAO would have their TXAU tokens locked; such tokens would not be transferrable until they were unpledged.

The DAO would be responsible for keeping the value of TXAU equal to the underlying physical bullion by automated computerized TXAU market operations. The DAO would have the ability to access TXAU secured in the DAO cryptoasset wallet to perform market operations (such as the automated arbitrage trading activities described below) to maintain a TXAU to London Good Delivery gold price peg. In one embodiment, the DAO could access the TXAU by transferring the TXAU out of the DAO controlled wallet to an external wallet of a third party in exchange for payment by the third party. The DAO could also accept TXAU from a third-party wallet into the DAO controlled wallet. Additionally, the DAO maintains a separate wallet for U.S. dollar stablecoins (such as USDC). The DAO could access the U.S. dollar stablecoins by transferring the U.S. dollar stablecoins out of the DAO controlled wallet to an external wallet of a third party in exchange for payment by the third party. The DAO could also accept U.S. dollar stablecoins from a third-party wallet into the DAO controlled wallet. Any trading value generated by market operations in the form of TXAU or U.S. dollar stablecoin in an amount greater than initially pledged to the DAO would be automatically allocated by automated computerized operations in five ways:

1. Payment of the underlying physical bullion storage fees associated with all TXAU tokens

2. Allocation to the DAO itself as compensation for generating the excess TXAU or U.S. dollar stablecoin. In one embodiment, GXAU holders are entitled to a pro rata amount of TXAU that has been allocated to the DAO. However, in a second embodiment, GXAU holders would not be entitled to a pro rate allocation of TXAU and would only have governance rights.

3. Allocation to an insurance pool to cover market operations of the DAO that may result in a loss of pledged TXAU

4. Allocation to holders of TXAU pledged to the DAO

5. Remaining purchased XAU is allocated to underlying TXAU asset holdings, making each TXAU token worth an increasing amount of physical London Good Delivery gold

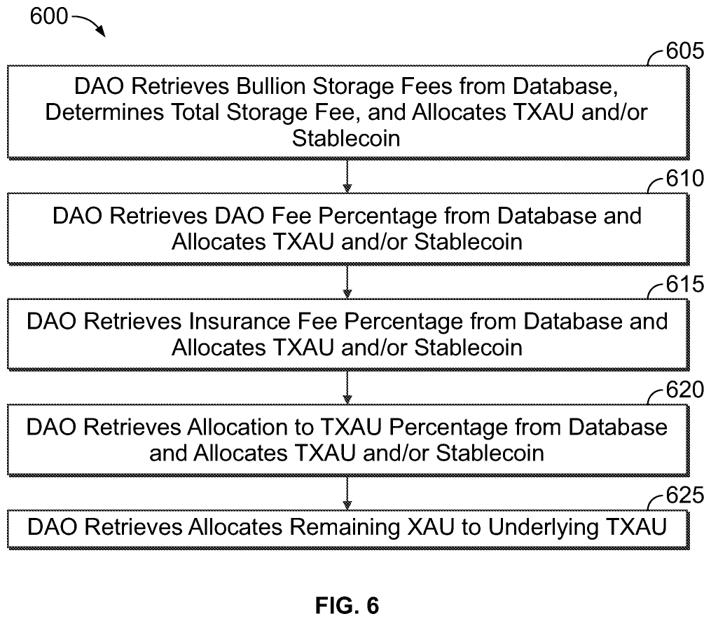

FIG. 6 illustrates a flowchart 600 of the allocation of TXAU and/or stable coin produced by automated market operations, according to an embodiment of the invention. As shown in FIG. 6, in one embodiment, the DAO would automatically allocate the proportion of the trading value generated by market operations in the following fashion. First, at step 605, an amount representing the fixed costs for the underlying physical bullion storage. For example, 5 basis per year/365 days per year, multiplied by the total amount of gold being stored. At step 610, with regard to the second factor identified above, an automatically calculated predetermined percentage stored in memory of 30% of the remaining trading value generated by market operations would be allocated to the DAO. At step 615, with regard to the third factor identified above, an automatically calculated predetermined percentage stored in memory of 10% of the remaining trading value generated by market operations would be allocated to the insurance pool. At step 620, with regard to the fourth factor identified above, an automatically calculated predetermined percentage stored in memory of 30% of the remaining trading value generated by market operations would be allocated to the holders of TXAU pledged to the DAO. Then, at step 625, any remaining value generated by market operations would be allocated to underlying TXAU asset holdings.

In a second embodiment, GXAU token holders would vote on the proportion of proceeds to be allocated in categories 2-5 above, with voting weights based on the number of GXAU held by voters. In one embodiment, every block equivalent to 30 days, the public addresses associated with GXAU holdings would electronically transmit a vote that would be calculated by the DAO on a pro rata basis based on GXAU holdings in the public wallet addresses holding GXAU.

In one embodiment, the GXAU token holders may electronically vote to set and/or alter the emission schedule of GXAU. Alternatively, the GXAU token holders may vote on the percentage of profits that are distributed to the insurance fund or underlying DAO itself, as described herein. Additionally, a secondary market in the GXAU token itself may develop because the GXAU token may be subsequently traded by private wallet addresses to which the GXAU has been transferred from the DAO.

Any holders of TXAU pledged to the DAO would receive GXAU emissions on a periodic pro rata basis corresponding with the amount of time the TXAU was pledged and the amount of TXAU pledged.

A minimum unpledging “cool off” period would ensure that the ratio of pledged TXAU tokens to underlying TXAU remained 1:1 (i.e. holders of pledged TXAU could not immediately unpledge their TXAU from the DAO while the DAO was using TXAU for market operations). In the case of TXAU, the unpledging period would last two LBMA business days. TXAU that has been unpledged and undergoing a “cool off” period would not be further accessible to the DAO for market operations, unless the market operations were already in progress.

Token Minting and Burning

Minting or burning of TXAU tokens would be done by the DAO at the prevailing ratio of London Good Delivery gold bullion per TXAU token, either in-kind, via fiat currency, or via cryptoasset currency at a predetermined spread range to the composite TXAU bid/ask prices. In-kind minting and burning of TXAU tokens could occur via the transfer of equivalent specie per coin (plus a creation/redemption fee). The prevailing ratio of London Good Delivery gold bullion per TXAU token would be calculated based on the sum of all London Good Delivery bullion in the DAO LBMA London vault account divided by the total number of TXAU tokens.

Market participants seeking to mint a TXAU token would request a creation quote from the DAO. Creation quotes could be delivered to the market participant via chat-based messaging or API, with the creation quote required to be within a prespecified range (such as 5 basis points) of the price broadcast by the DAO's oracle. Upon agreeing to a transaction price, the market participant would transfer the agreed upon payment to the DAO, who would in turn send the agreed upon number of tokens to the market participant. Trading fees would be applied via a haircut to the number of tokens delivered to the market participant. In one embodiment, the TXAU tokens that is minted is sent to the public wallet address of the entity that requested the TXAU mint. The entity may simply hold the TXAU in its wallet or may alternatively proceed as described above to request whitelisting so that the entity may pledge the TXAU by transferring it to the wallet controlled by the DAO.

Example 1—Token Mint: A market participant seeks to mint 100 TXAU tokens. The prevailing ratio of London Good Delivery gold bullion per TXAU token is 1.001 (example assumes that 1,001,000 fine troy oz of bullion backs 1,000,000 TXAU tokens). The fee schedule for creating 100 TXAU tokens is 0.10%.

The DAO provides a quote of $180,180 based on the minting of 100 TXAU tokens at a price of $1,800 per oz (equal to $1,800×100×1.001). The DAO receives payment from the market participant, mints 100 TXAU tokens, and sends 99.9 tokens to the market participant (based on the fee schedule of 0.10%). The DAO would keep the remaining 0.10 tokens as a fee.

The DAO mints TXAU tokens by purchasing an equivalent amount of LBMA Good Delivery physical gold and depositing the gold via a segregated LBMA member vault. (LBMA London Good Delivery bullion has a T+2 settlement schedule. Stake pool operators holding TXAU for market making purposes could deliver TXAU tokens to a market participant on T+0 in certain circumstances; creations over a certain size would require TXAU delivery on a T+2 basis.) TXAU tokens are minted by the DAO when the LBMA member vault verifies via electronic message the net receipt of the underlying bullion inflows in the vault account on a daily basis. The DAO managing vaulting operations in a segregated account at an LBMA approved vault in London is responsible for ensuring that the total vault holdings published by its oracle is equal to the new total physical gold bullion backing the TXAU tokens post creation activity.

Example 2—Token Burns: A market participants seeks to burn 100 TXAU tokens. The prevailing ratio of London Good Delivery gold bullion per TXAU token is 1.001 (example assumes that 1,001,000 fine troy oz of bullion backs 1,000,000 TXAU tokens). The fee schedule for burning 100 TXAU tokens is 0.10%.

The DAO provides a quote of $179,999.82 based on the burn of 99.90 TXAU tokens at a price of $1,800 per oz (equal to $1,800×100×1.001×0.9990). The DAO receives payment in the form of 100 TXAU tokens from the market participant, burns 99.99 TXAU tokens, and sends $179,999.82 to the market participant (based on the fee schedule of 0.10%). The DAO would keep the remaining 0.10 tokens as a fee.

The DAO burns TXAU tokens by selling an equivalent amount of LBMA Good Delivery physical gold held within a segregated LBMA member vault. TXAU tokens are burned by the DAO when the LBMA member vault verifies via electronic message the net receipt of the underlying bullion outflows in the vault account on a daily basis. To accomplish the burn operation, the DAO identifies the tokens to be burned and initiates the transfer of the identified tokens to a burn address on the blockchain. Any tokens sent to the burn address are no longer available on the blockchain. The DAO is responsible for ensuring that the total vault holdings published by its oracle is equal to the new total physical gold bullion backing the TXAU tokens post redemption activity.

Example 3—Creation In-Kind: A market participant seeks to mint 100 TXAU tokens by transferring London Good Delivery bullion to DAO. The prevailing ratio of London Good Delivery gold bullion per TXAU token is 1.001 (example assumes that 1,001,000 fine troy oz of bullion backs 1,000,000 TXAU tokens). The fee schedule for minting 100 TXAU tokens is 0.10%.

The DAO provides a quote of 100.200200 fine troy ounces (rounded to 100.200 per LBMA methodology) based on the mint of 100 TXAU tokens (equal to 100×1.001×100/99.90). The DAO receives 100.200 fine troy oz of London Good Delivery bullion from the market participant, mints 100.099900 TXAU tokens, and sends 100 TXAU tokens to the market participant. The DAO would keep the remaining 0.099900 tokens minted as a fee.

Mechanics of the DAO when Token Trades at a Premium to the Physical Asset:

TXAU tokens would be expected to naturally trade at a premium to the underlying physical asset due to the absence of holding fees and negative carry. If the price premium of TXAU tokens in comparison to the underlying physical asset were to widen to a level where arbitrage operations were economically viable, the DAO would be incentivized to perform automated computerized market operations to capture the arbitrage opportunity. In one embodiment, the arbitrage operations become economically viable when the TXAU price premium to XAU exceeds the trading transaction costs (including but not limited to exchange transaction fees when buying TXAU on a cryptoasset exchange or XAU clearing and commission fees) and execution slippage costs.

In the case of TXAU trading at a price premium to the underlying physical asset, the DAO would sell TXAU on liquidity venues or via OTC transactions, use the corresponding proceeds to purchase London Good Delivery bullion on liquidity venues or via OTC transactions, and proceed with a TXAU token creation process to transform the London Good Delivery bullion into TXAU tokens. With proper execution, this series of trades would result in a higher amount of London Good Delivery bullion backing each TXAU token than prior to the series of trades.

### Embodiment One: Single DAO

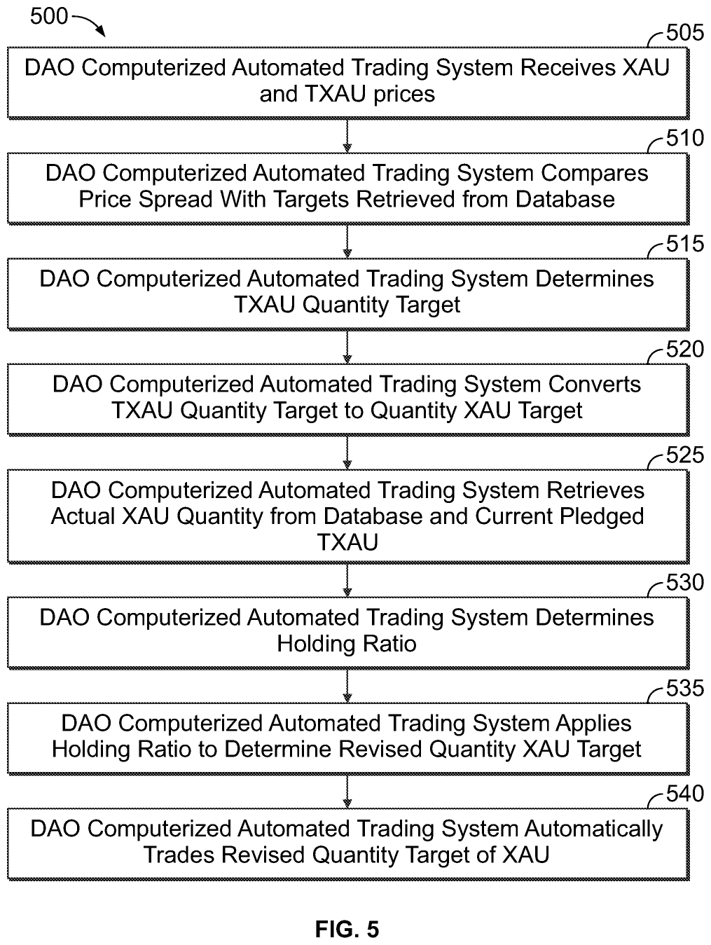

FIG. 5 illustrates a flowchart 500 of the DAO automated computerized trading system, according to an embodiment of the present invention. As shown in FIG. 5 at step 505, in one embodiment, the DAO includes a computerized automated trading system that continually receives data from multiple London Good Delivery bar spot liquidity venues streaming executable XAU prices via API during LBMA business hours. API connectivity would include order execution and/or streaming market data in the form of buy and sell prices and corresponding quantities. XAU liquidity venues could include, but would not be limited to, over-the-counter (OTC) brokers and principal trading firms, central limit order books (GLOB s), and liquidity aggregators. The DAO computerized automated trading system would also connect to multiple streaming executable TXAU or other executable tokenized gold product prices via API to ingest market data and/or execute trading orders. TXAU or other executable tokenized gold product liquidity venues could include, but would not be limited to, cryptoasset exchange CLOBs, OTC brokers and principal trading firms, liquidity aggregators, and DeFi cryptoasset protocols.

As shown at step 510, a set of default price spread targets is input by the DAO to the automated computerized trading system and stored in memory. The price spread targets would correspond to the price premium (or discount) of TXAU and the underlying physical asset (XAU), or to the price premium (or discount) of a physically redeemable asset with XAU backing.

At step 515, a set of default quantity targets in TXAU terms associated with the default price spread targets (premiums and discounts) would be input to the automated computerized trading system by the DAO and stored in memory. Quantity targets would be input by the DAO in terms of a percentage of TXAU pledged to the DAO, and converted to TXAU trading instrument unit terms by the automated computerized trading system. The TXAU quantity targets in trading instrument unit terms per price spread target would automatically update as the number of TXAU tokens pledged to the DAO changed. The automated computerized trading system would subscribe to a TXAU blockchain API data feed to automatically track and store in memory the number of TXAU tokens pledged to the DAO.

The automated computerized trading system would reference from memory and multiply the two variables of: 1) the quantity target in percentage of TXAU pledged to the DAO terms, and 2) the number of TXAU tokens pledged to the DAO. The automated computerized trading system would also track and store in memory the net number of TXAU tokens that had been traded over the course of the trading period. (For the purposes of tokenized gold bullion, a trading period is defined as a LBMA business day. Trading activity that takes place after the close of an LBMA business day would be associated with the subsequent LBMA business day.)

At step 520, TXAU quantity targets are automatically converted by the automated computerized trading system into a corresponding equivalent number of XAU units or units of a physically redeemable gold backed instrument based on the number of fine troy ounces of gold backing each instrument. The automated computerized trading system continuously ingests 1) the DAO oracle API feed of daily Good Delivery bar bullion vault holdings specifying the number of fine troy ounces of gold associated with TXAU under its operational control, and 2) the TXAU blockchain API to automatically determine the number of TXAU tokens in existence.

At step 525, the automated computerized trading system retrieves from a database at the DAO the actual XAU quantity of fine troy ounces that has been actually received and stored. The exact amount of fine troy ounces received and stored may vary by fractions of an ounce from bar to bar and consequently may differ from the declared weight at the time of a previous trade. To maintain precision, the exact quantity of ounces of physical gold that are held is measured and stored in a database at the DAO.

At step 530, the automated computerized trading system automatically divides the daily number of Good Delivery bar bullion vault actual holdings in fine troy ounces by the number of TXAU tokens in existence to determine the number of fine troy ounces per TXAU token, and store this number in memory (hereafter referred to as the TXAU holdings ratio), as shown at step 530. The TXAU holdings ratio is used to represent the actual numbers of fine troy ounces in held gold bullion vs. the number of TXAU tokens in existence. This is valuable to account for differences between the stated weight of gold bullion as opposed to the reported weight at trading.

At step 535, the automated computerized trading system applies the holding ratio to the Quantity XAU target to determine a revised quantity XAU target. Thus, the automated computerized trading system subsequently converts the TXAU quantity target into a corresponding target of XAU (or XAU equivalent) units by referencing the TXAU holdings ratio in memory.

Holdings ratios specifying the amount of fine troy ounces of gold backing a single unit of any instrument tradeable by the automated computerized trading system are input to the automated computerized trading system by the DAO and stored in memory in a database at the DAO. The automated computerized trading system would multiply the TXAU holdings ratio by the holdings ratio of any other instrument to generate the quantity ratio equivalency between the instrument pair, storing the quantity equivalency ratio in memory. In the case of XAU, the quantity ratio equivalency would be equal to the TXAU holdings ratio divided by 1.

At step 540, the DAO computerized automated trading system automatically trades the revised quantity target of XAU. Further, as automated trading activity occurred over the course of the trading period, the automated computerized trading system would constantly reference the net number of TXAU tokens that had been traded over the course of the trading period in memory. The automated computerized trading system would reduce the default cumulative TXAU quantity target stored in memory by the net number of TXAU tokens that had been traded over the course of the trading period to calculate the marginal remaining TXAU quantity target at each price target.

### Example

The prevailing ratio of London Good Delivery gold bullion per TXAU token is 1.001. The example assumes that 1,001,000 fine troy oz of bullion (XAU) back 1,000,000 TXAU tokens. The quantity ratio equivalency of XAU:XAU, used to determine the amount of fine troy ounces in XAU, is 1:1.

1.001=(1,001,000/1,000,000)×1

100,000 TXAU tokens are pledged to the DAO. Default price spread targets and default quantity targets at time=T are outlined below.

In a case where the automated trading system determines that TXAU is trading at a premium of $3.50 to its underlying asset value, the automated trading system would target to sell 250 TXAU tokens and purchase a corresponding quantity of 25,025 physical gold bullion fine troy ounces via XAU. If no other trades had been executed by the automated computerized trading system during the trading period, the net number of TXAU tokens stored in memory as traded would be zero. If the automated trading system was successful in selling 250 TXAU tokens at a premium of $3.50 or better, while simultaneously selling 25,025 XAU units, the net number of TXAU tokens stored in memory as traded would increase to 25,000 units.

TABLE 1

| | Default TXAU | Default TXAU | Corresponding |
|---|---|---|---|
| Default | Quantity Target | Quantity Target | Quantity Target |
| Price | (cumulative % of | (cumulative TXAU | in XAU Units (1 |
| Spread | pledged TXAU | token target trading | XAU = 1 fine |
| Target | tokens) | position level) | troy oz of gold) |
| $3.00 | 25% | 25,000 | 25,025 |
| $5.00 | 50% | 50,000 | 50,050 |
| $7.00 | 100% | 100,000 | 100,100 |

Following the success sale of 25,000 TXAU tokens (and assuming no other trades at T+30 min), the automated computerized trading system would reference from memory that 250 TXAU tokens were sold out of 100,000 TXAU tokens pledged to the DAO, representing a target rate of 25% (=25,000/100,000). Baring no changes to the premium of TXAU to XAU, or the amount of TXAU tokens pledged, no further automated trading activity would occur.

If 10,000 additional TXAU tokens were pledged to the DAO at T+45 min and the premium of TXAU to XAU remained at $3.50, the automated computerized trading system would calculate that 6,250 additional TXAU would be targeted for automated sale (=25%×125,000=31,250 TXAU target—25,000 TXAU sold=6,250 TXAU).

In one example, if the value of TXAU is below the value of XAU, then the automated computerized system may sell XAU and buy TXAU.

Conversely, when the value of TXAU is higher than the value of XAU, then the automated computerized system may sell TXAU and buy XAU. It is noted in this case that both the sale of TXAU and purchase of XAU may take place immediately.

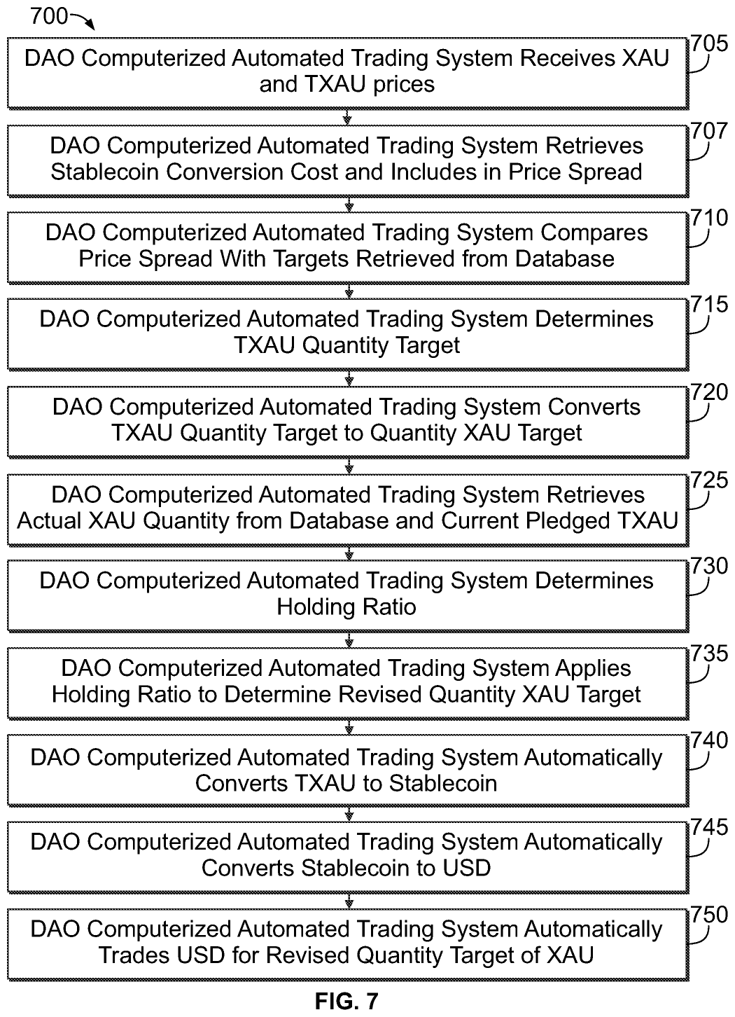

FIG. 7 illustrates a flowchart 700 of the DAO automated computerized trading system wherein TXAU is automatically converted to stable coins which are then used to automatically purchase XAU, according to an embodiment of the present invention. The flowchart 700 of FIG. 7 is generally similar to the flowchart 500 of FIG. 5 with the addition of steps 707, 740, 745, and 750. Thus, steps 705, 710, 715, 720, 725, 730, and 735 proceed as generally described above for the corresponding steps in FIG. 5.

However, at step 707, the DAO computerized automated trading system retrieves the cost to convert TXAU to stablecoin. This cost may be fixed or varying and may be monitored using an API data feed from one or more coin conversion entities. The conversion cost is then included in the price spread between XAU and TXAU to determine when the price spread exceeds the predetermined, stored threshold difference to initiate automated trading activity.

At step 740, once the DAO computerized automated trading system has determined the revised quantity XAU target, the DAO computerized automated trading system automatically initiates a conversion of TXAU to stablecoin. The conversion of TXAU to stablecoin takes into account the conversion cost so that the quantity of stablecoin available after conversion is equal to the amount needed to purchase the revised quantity XAU target. In one embodiment, the stablecoin may be USDC.

At step 745, the DAO computerized automated trading system automatically initiates a conversion of stablecoin to a fiat currency, such as US dollars, for example, or other currency such as euros.

Finally, at step 750, the DAO computerized automated trading system automatically initiates a trade to trade the US dollars for the revised quantity XAU target.

In another embodiment, the DAO computerized automated trading system may monitor an API feed from an exchange that lists trading pairs such as TXAU vs. US dollar (or other currency) or TXAU vs. USDC. Similar to as described above for trading XAU based on the a revised quantity target, he DAO computerized automated trading system may then trade one or more of the available trading pairs.

To determine the existing price spread between TXAU and underlying physical asset, the automated computerized trading system would monitor the market data received via API feeds. The automated computerized trading system would view top of book bid and ask prices of instruments representing physically backed assets, and compare these prices to the top of book bid and ask prices of TXAU liquidity sources received via API. Multiple price spread calculations would be maintained simultaneously by the automated computerized trading systems, representing spread pairs from different liquidity venues. For example, the automated computerized trading system would generate a spread calculation by taking the TXAU bid price on liquidity venue A, and subtracting the XAU ask price on liquidity venue B. The resulting spread metrics for each trading pair would be near instantaneously compared to the default price spread threshold target stored in the memory by the automated computerized trading system.

Once the automated trading system determines TXAU on a liquidity venue is trading at a premium (or discount in a second embodiment of the invention) to its underlying asset value on a liquidity venue, and that the difference between the current sell price of TXAU and the current buy price of gold is greater than the predetermined threshold price difference stored in memory at the DAO (or less than the predetermined discount threshold in a second embodiment of the invention), the automated trading system automatically queries from memory the marginal remaining TXAU quantity target at the corresponding price target. If the marginal remaining TXAU quantity target at the corresponding price target is greater than zero, and TXAU is trading at a premium to XAU, the automated trading system automatically initiates the sale of TXAU and the purchase of XAU or gold backed instrument. The automated sale of TXAU and the near instantaneous purchase of XAU or gold backed instrument (or the automated purchase of TXAU and the near instantaneous sale of XAU or gold backed instrument), shall hereafter be referred to as automated pair spread arbitrage trading activity. The associated sale of TXAU and purchase of XAU or gold backed instrument is stored in the memory of the automated trading system, with the resulting net number of TXAU tokens that had been traded over the course of the trading period and corresponding marginal remaining TXAU quantity target each automatically updated by the automated computerized trading system to reflect the trades. (In a second embodiment of the invention, the directions of the trades would be reversed if TXAU were trading at a discount to XAU and the automated computerized trading system were to execute a trade purchasing TXAU and selling XAU.)

In one embodiment of the invention, to execute the spread trade among a TXAU and XAU trading pair where the TXAU premium crosses a threshold level stored in memory, the automated computerized trading system sends an immediate or cancel (IOC) order to the top of each instrument's corresponding order book or order book equivalent. If that IOC order wasn't fully-filled, the automated computerized trading system would send an additional IOC orders at the latest top of book price until the order is filled.

In a second embodiment of the invention, to execute the spread trade among a TXAU and XAU trading pair where the TXAU premium crosses a threshold level stored in memory, the automated trading system would begin by watching the XAU top of book price for the trading pair received by API. The automated computerized trading system would reference the XAU top of book price for the trading pair and automatically add the target spread price stored in memory to the XAU top of book price to calculate a target TXAU bid price. The automated computerized trading system would automatically rest an order in the TXAU orderbook at the corresponding target TXAU bid price. The automated computerized trading system would automatically adjust the resting order price in the TXAU orderbook as the XAU top of book price changed, in order to keep the spread between TXAU order and XAU top of book price equal to the target spread price stored in memory.

The automated computerized trading system would constantly query from its memory the net number of TXAU tokens that had been traded over the course of the trading period and multiply this number by the TXAU holdings ratio held in memory; the resulting output of net fine troy ounces associated with TXAU tokens that had been traded during the trading period would be stored in memory, and will hereafter be referred to as net TXAU fine troy ounces traded. Simultaneously, the computerized trading system would constantly query from its memory the net number of ounces of XAU and number of units of gold backed instruments that had been traded over the course of the trading period and automatically multiple these quantities by the holdings ratio of these instruments. The resulting sum of the net number of fine troy ounces of XAU plus net number of fine troy ounce of other gold backed instruments would be stored in memory, and will hereafter be referred to as net XAU fine troy ounces traded. The automated computerized trading system would constantly query from its memory the net TXAU fine troy ounces traded and compare this metric to the net XAU fine troy ounces traded. An imbalance limit would be input to the automated computerized trading system by the DAO that would automatically limit the absolute value difference between the net TXAU fine troy ounces traded and the net XAU fine troy ounces traded; the absolute value difference between the two metrics will hereafter be referred to as the absolute trading imbalance.

If the absolute trading imbalance reaches a predetermined limit entered by the DAO and stored in memory of the automated computerized trading system, the automated computerized trading system would automatically check its memory to ensure arbitrage trading market conditions are met. In the case of a TXAU premium arbitrage, arbitrage trading market conditions are met when 1) the price of TXAU trades at or above a default spread target price to XAU, and 2) the marginal remaining TXAU quantity target associated with the current price spread between TXAU and XAU is greater than zero. If the absolute trading imbalance reaches a predetermined limit and the arbitrage trading conditions are met, the automated computerized trading system would automatically grab from its memory the lower absolute value of either the net TXAU fine troy ounces traded or the net XAU fine troy ounces traded. In the case of a TXAU premium arbitrage, if the lowest absolute value was the net TXAU fine troy ounces traded, the automated computerized trading system would automatically sell TXAU in a quantity equivalent to the absolute trading imbalance limit. The quantity equivalent to the absolute trading imbalance limit would be automatically calculated by the automated computerized trading system by dividing the trading imbalance limit by the TXAU holdings ratio held in memory, and rounding down to the smallest tradeable unit. In the case of a TXAU premium arbitrage, if the lowest absolute value of either the net TXAU fine ounces traded or the net XAU fine troy ounces traded was the net XAU fine troy ounces traded, the automated computerized trading system would automatically buy XAU in a quantity equivalent to the absolute trading imbalance limit. The automated computerized trading system activity of automatically selling TXAU or buying XAU in a quantity equivalent to the absolute trading imbalance limit during period of TXAU premium arbitrage shall hereafter be referred to as imbalance hedging activity.

The automated computerized trading system would pause all automated pair spread arbitrage trading activity if the absolute trading imbalance reached a predetermined limit in order to prevent the absolute trading imbalance from growing. The automated computerized trading system would automatically execute imbalance hedging activity until the absolute trading imbalance fell below the predetermined limit. The automated computerized trading system would resume automated pair spread arbitrage trading activity as soon as the absolute trading imbalance fell below the predetermined limit.

A set of default trading incremental order sizes would be input by the DAO to the automated computerized trading system and stored in memory. The incremental order sizes would be unique to each tradeable instrument and the liquidity platform on which the instrument was traded. The incremental order size would limit the size of each order routed to the top of each instrument's corresponding order book or order book equivalent. For example, the incremental order size of the XAU instrument traded on the Electronic Broking Services (EBS) Market CLOB platform could be (1) ounce of XAU. The automated computerized trading system would send additional orders at the latest top of book price if the TXAU premium to the XAU instrument remained above a threshold target level stored in memory after each incremental order size is filled until either 1) the TXAU premium to the XAU instrument fell below a threshold target level stored in memory, or 2) the marginal remaining TXAU quantity target at the corresponding threshold target level stored in memory reached zero.

In instances where an instrument unit size is smaller than one fine troy ounce of gold and the automated computerized is performing automated pair spread arbitrage trading activity, the automated computerized trading system would send an order to the top of the instrument's corresponding order book or order book equivalent and buy/sell the maximum available number of units available at the top of book up to the amount of fine troy gold ounces equivalent in the other pair involved in the automated pair spread arbitrage trading activity. Any resulting absolute trading imbalances would be stored in memory, with automated imbalance hedging activity occurring once the absolute trading imbalance limit stored in memory were met.

Mechanics of the DAO when Token Trades at a Discount to the Physical Asset:

In the case of TXAU trading at a price discount to the underlying physical asset (the automated trading steps performed by the DAO are similar to as discussed above but in reverse), the DAO or market participants would purchase TXAU on liquidity venues or via OTC transactions, and redeem TXAU for London Good Delivery bullion via in-kind redemption mechanisms facilitated by stake pool operators. London Good Delivery bullion could then be sold to capture any premiums from the arbitrage opportunity. This series of trades would result in a profit for the DAO or market participants that engaged in the trade, with no impact to the amount of London Good Delivery bullion backing each remaining TXAU token.

In a second embodiment of the invention, as discussed above, the holders of TXAU that pledge TXAU to the DAO would be required to also pledge to the DAO a fractional amount of the notional value of the TXAU via a U.S. dollar stablecoin, for example USDC. The pledge of the TXAU and the pledge of the U.S. dollar stablecoin would occur near simultaneously, with the pledged U.S. dollar stablecoin sent to a cryptographic wallet controlled by the DAO. The U.S. dollar stablecoins pledged to the DAO would be locked from movement except for use by the DAO. The U.S. stablecoins would be used by the DAO for automated computerized trading when the value of TXAU traded at a price discount to the underlying physical asset. For example, when TXAU is trading at a discount to XAU (which represents the underlying price of physical gold in U.S. dollars), the DAO would automatically use USDC to purchase TXAU, while simultaneously selling XAU. The amount of USDC usable by the DAO is all pledged USDC. The amount of XAU usable by the DAO is equivalent to the quantity ratio equivalency of all locked TXAU controlled by the DAO.

Mechanics of the DAO when the Underlying Physical Asset Exhibits Positive Carry:

Preceding descriptions of the DAO activities pertained to underlying physical assets that exhibit negative holding costs. However, the same token and governance mechanisms would be applied to assets with positive holding economics, such as U.S. dollar holdings in a positive interest rate environment. The receipt of positive cash flow by the DAO would be allocated to the DAO, an insurance pool, and underlying token holdings, making each token worth an increasing amount of the underlying physical asset—in the same way as described in the SYSTEM OF GOVERNANCE section.

In one embodiment, instead of using XAU as an underlying physical asset for a TXAU token, a U.S. dollar based stablecoin using U.S. dollars as an underlying asset which generates positive interest may be used. The trading and governance operations discussed above would also apply.

Mechanics of Loss Management During DAO Market Operations:

During the course of DAO market operations undertaken when TXAU is trading at a premium to London Good Delivery bullion, losses may be incurred if the DAO is unable to return a higher amount of TXAU than originally withdrawn from the DAO liquidity pool. In the event of a loss, the deficit between the amount of TXAU withdrawn by the DAO and the amount returned by the DAO over a T+2 period would be distributed pro rata among the participants that pledged TXAU to the DAO. These pledged TXAU tokens would be locked and a corresponding number of TXAU tokens subsequently burned such that the ratio of the number of pledged TXAU tokens to TXAU locked in the DAO remained at 1:1.

If the losses incurred by the DAO were to be greater than the number of pledged TXAU tokens, TXAU held in an insurance pool developed through the allocation of earnings associated with historical stake pool operator market operations would be used to cover the residual loss.

Systems for Use with Other Metals Such as Silver:

The embodiments of the invention described above with regard to gold bullion and a gold backed token may also be used for other assets including commodities such as silver or other metals. For example, with regard to a silver implementation, such an embodiment would include silver stored in a LBMA approved London vault similar to the manner in which gold was stored above. The DAO would have a similar application to that described above, the token would be constructed as described above, and the smart contract would be constructed in the same manner as described above. Consequently the token, smart contract, and DAO would function similarly to the gold embodiment as described above, except for: 1) the underlying metal itself, 2) the input to the DAO would include silver pricing rather than gold pricing from the liquidity sources listed above, and 3) the DAO would receive the input prices for the silver token from the cryptoasset liquidity sources listed above. The remaining functional aspects described above would remain the same.

With regard to a platinum implementation, such an embodiment would include platinum stored in a LBMA approved Zurich vault similar to the manner in which gold was stored above. A second embodiment would include platinum stored in a LBMA approved London vault similar to the manner in which gold was stored above. The DAO would have a similar application to that described above, the token would be constructed as described above, and the smart contract would be constructed in the same manner as described above. Consequently the token, smart contract, and DAO would function similarly to the gold embodiment as described above, except for: 1) the underlying metal itself, 2) the input to the DAO would include platinum pricing rather than gold pricing from the liquidity sources listed above, and 3) the DAO would receive the input prices for the platinum token from the cryptoasset liquidity sources listed above. The remaining functional aspects described above would remain the same.

With regard to a palladium implementation, such an embodiment would include palladium stored in a LBMA approved Zurich vault similar to the manner in which gold was stored above. A second embodiment would include palladium stored in a LBMA approved London vault similar to the manner in which gold was stored above. The DAO would have a similar application to that described above, the token would be constructed as described above, and the smart contract would be constructed in the same manner as described above. Consequently the token, smart contract, and DAO would function similarly to the gold embodiment as described above, except for: 1) the underlying metal itself, 2) the input to the DAO would include palladium pricing rather than gold pricing from the liquidity sources listed above, and 3) the DAO would receive the input prices for the palladium token from the cryptoasset liquidity sources listed above. The remaining functional aspects described above would remain the same.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An automated computerized trading system for blockchain-based tokens, said system including:
a computerized decentralized autonomous organization (DAO) having a cryptoasset wallet, wherein said cryptoasset wallet includes a quantity of cryptoassets that are stored on a blockchain,
wherein said DAO includes a memory storing a price spread target associated with a predetermined percentage of said quantity of cryptoassets,
a commodity price Application Programming Interface (API) providing commodity price data for a commodity to said DAO; and
a cryptoasset Application Programming Interface (API) providing cryptoasset price data for said cryptoasset to said DAO;
wherein, when the difference between said commodity price data and said cryptoasset price data exceeds said price spread target, said DAO determines a cryptoasset quantity target by multiplying said quantity of cryptoassets by said predetermined percentage,
wherein said DAO converts said cryptoasset quantity target to a commodity quantity target based on said commodity price data, and
wherein said DAO automatically initiates trading of said commodity based on said commodity quantity target.

2. The system of claim 1 wherein said memory includes a plurality of different price spread targets associated with different percentages of said quantity of cryptoassets.

3. The system of claim 1 wherein said cryptoassets are received from a plurality of wallets, each having a public wallet address.

4. The system of claim 1 wherein said DAO includes a database storing said public wallet address and the quantity of cryptoassets received from said public address.

5. The system of claim 1 further including a first smart contract for said cryptoassets operating on said blockchain.

6. The system of claim 5 wherein said public wallet address and the quantity of cryptoassets received from said public wallet address stored in said first smart contract.

7. The system of claim 6 further including a governance smart contract and a governance cryptoasset stored on said blockchain.

8. The system of claim 7 wherein said DAO includes a database storing a governance cryptoasset emission schedule indicating an emission amount of said governance cryptoasset.

9. The system of claim 8 wherein said governance smart contract receives said public wallet address and the quantity of cryptoassets received from said public wallet address stored in said first smart contract.

10. The system of claim 9 wherein said governance smart contract determines a total quantity of cryptoassets by summing said quantity of cryptoassets received from said public wallet address stored in said first smart contract.

11. The system of claim 10 wherein said governance smart contract allocates an emission amount of said governance cryptoasset to each of said public wallet address based on their pro-rata share of said quantity of cryptoassets.
